(19) United States
(12) Patent Application Publication
(10) Pub. No.: US 2017/0256814 A1
(43) Pub. Date: Sep. 7, 2017

(54) MAGNESIUM BATTERY AND METHOD OF ACTUATING

(71) Applicant: Jacuni Technology, Inc., Alhambra, CA (US)

(72) Inventors: Hatsuki Ebata, Alhambra, CA (US); Mitsunobu Takemura, Nara (JP)

(21) Appl. No.: 15/059,243

(22) Filed: Mar. 2, 2016

(51) Int. Cl. H01M 10/054; H01M 2/16; H01M 4/133; H01M 4/38; H01M 10/0562; H01M 4/134

(52) U.S. Cl. CPC H01M 10/054; H01M 10/0562; H01M 4/134; H01M 4/133; H01M 4/381; H01M 2/1626

(57) ABSTRACT

A magnesium battery and method of actuating the battery comprises a cathode that generates electrons and is fabricated from magnesium metal or magnesium alloy. The cathode is coated by carbon nanotubes having hydrophilic characteristics. An anode absorbs electrons that are generated by the cathode. This generated flow of electrons enables formation of a circuit. An insulation plate also absorbs electrons and has a conductive porous material with characteristics of absorbency and charge induction. An electrolyte solution coats the anode and/or the insulation plate. The anode and the insulation plate becomes conductive upon absorption of the electrolyte solution. The electrolyte solution comprises at least one of sea salt, glutamine sodium, calcium carbonate, and trisodium citrate. The battery is actuated by immersion of the cathode, the anode, and the insulation plate in a solvent. The battery may operatively connect to and power an illumination device upon immersion in the solvent.

### FIELD OF THE INVENTION

The present invention relates generally to a magnesium battery and method for actuating. More so, a magnesium battery powers an illumination device through enhanced ionization by a magnesium metal or magnesium alloy; whereby the magnesium battery comprises of a cathode fabricated at least partially from magnesium, a plurality of carbon nanotubes that coat the cathode, an anode, an insulation plate comprised of a conductive porous material having characteristics of absorbency and charge induction, and an electrolyte solution comprising sea salt, glutamine sodium, calcium carbonate, and trisodium citrate that coats the anode and/or the insulation plate; whereby the battery is actuated by immersion of the cathode, the anode, and the insulation plate in a solvent for actuation of the magnesium battery, and thereby the illumination device.

### BACKGROUND OF THE INVENTION

Typically, a battery electric battery is a device consisting of two or more electrochemical cells that convert stored chemical energy into electrical energy. Each cell has a positive terminal, or cathode, and a negative terminal, or anode. The terminal marked positive is at a higher electrical potential energy than is the terminal marked negative. The terminal marked positive is the source of electrons that when connected to an external circuit will flow and deliver energy to an external device.

Often, when a battery is connected to an external circuit, electrolytes are able to move as ions within, allowing the chemical reactions to be completed at the separate terminals and so deliver energy to the external circuit. It is the movement of those ions within the battery which allows current to flow out of the battery to perform work.

In recent years, the global market widespread of small electronic devices such as laptop computers and especially smart phones have increased the demand for lithium-ion rechargeable batteries at a rapid pace. Economical, lightweight with high capacity rechargeable batteries will show even higher demands.

It is known that a magnesium-ion battery integrates multivalent ions like Magnesium ions instead of Lithium ions in a rechargeable battery. The objective of developing the Magnesium ion battery is to produce a battery that is twice as efficient in power delivery, cheaper, and also easier to manufacture as Mg-ions are much more abundant than Li-ions. Though light and powerful lithium-ion batteries enables myriad electrical devices. But lithium is expensive and the range of devices that run off the Lithium-ion battery is still limited making the technology a tough sell.

It is known that Magnesium fuel cell consists mainly of magnesium, a substance which is low in price, virtually unlimited in amount, and has a long history of being researched. However, as the magnesium hydroxide created in the reaction is too highly stable to be used as a rechargeable battery, and furthermore as the metallization of the magnesium oxide; i.e. the deoxidization, requires a vast amount of energy, it was considered difficult to be realized from the economic stand point.

Nevertheless in recent years with the advancement of research, the previous challenges are being overcome, and with its fuel cell capacity of theoretically double the amount compared to Lithium ion rechargeable batteries, it has been attracting attention as the next generation rechargeable battery.

In general for cathode of magnesium fuel cells, thin plates or even thinner membrane with good electro conductivity metals such as copper, stainless steel, aluminum, cast metal or in other cases electro conductive carbon such as graphite and black can be seen. To make it more light and compact as a fuel cell to make it more efficient, it is ideal to have it much thinner to have wider contact area of electric connection with the electrolyte.

In general the electrolyte for magnesium fuel cells, acid substances such as the sulphonic acids, citric acid, oxalic acid, and sometimes alkaline substances such as the sodium salts are used. Therefore as an electrode, substances which are chemically stable and does not change its characteristics over time are necessary.

As a chemically balanced substances for electrode, electro conductive carbon are considered or partially used in products. However, as electro conductive carbon originally comes in the form of powder, and require a binder for coating on to the base material, the binder disrupts the electro conductivity and thus ends up lowering the conductivity.

In general electrolytes from the stand point of safety and prevention of leakage, is water based. Thus, the electrode interface requires to be hydrophilic. On the other hand carbons are chemically stable but are not hydrophilic, and of the carbon group, graphite are water repellent making it dysfunctional as electrodes.

Other proposals have involved magnesium-ion batteries. The problem with these batteries is that they are not chemically stable, create excessive oxidation, are heavy, are expensive, and require a binder for coating on to the base material.

Thus, an unaddressed need exists in the industry to address the aforementioned deficiencies and inadequacies. Even though the above cited magnesium-ion batteries meets some of the needs of the market, a magnesium battery and method of actuating the battery is still desired.

### SUMMARY OF THE INVENTION

The present invention is directed to a magnesium battery and method for actuating the magnesium battery. The magnesium battery comprises of a cathode that generates electrons and is fabricated at least partially from magnesium. The cathode is coated by a plurality of carbon nanotubes having hydrophilic characteristics. The battery further comprises an anode configured to absorb electrons that are generated by the cathode. This generated flow of electrons enables formation of a circuit. The battery further comprises an insulation plate configured to absorb the electrons. The insulation plate has a conductive porous material with characteristics of absorbency and charge induction.

In some embodiments, an electrolyte solution at least partially coats the anode and/or the insulation plate. The anode and the insulation plate becomes conductive upon absorption of the electrolyte solution. The electrolyte solution comprises at least one of the following: sea salt, glutamine sodium, calcium carbonate, and trisodium citrate. In another embodiment, the electrolyte solution may also include calcium carbonate and/or citrate.

In some embodiments, a solvent actuates the battery through immersion of the cathode, the anode, and the insulation plate in the solvent. In one embodiment, the battery powers an illumination device upon immersion in the solvent. The unique configuration of the cathode, anode, and insulation plate enables the battery to provide numerous advantages over the prior art.

In one embodiment, the unique magnesium metal or magnesium alloy composition of the cathode enhances ionization so as to help inhibit corrosion caused by excessive oxidation. This is possible because the magnesium metal forms a protective film that inhibits oxidation, when engaged with a solvent. Upon engagement with the solvent, the protective film forms through a non-dynamic dissolution. The carbon nanotubes that coat the cathode enhance conductivity. The electrolyte solution that coats the anode and insulation plate enhance absorption of electrons generated by the cathode. Further, the battery has an appropriate reactive nature and can start activating power by a simple operation, even after a long preservation.

In one aspect, a magnesium battery, comprises:
a cathode, the cathode comprising magnesium and a generally hydrophilic material, the cathode configured to generate electrons;
a plurality of carbon nanotubes, the plurality of carbon nanotubes configured to at least partially coat the cathode, the plurality of carbon nanotubes defined by a generally hydrophilic configuration;
an electrolyte solution, the electrolyte solution comprising of at least one of the following: sea salt, glutamine sodium, calcium carbonate, and trisodium citrate, the electrolyte solution configured to initiate the generation and absorption of electrons;
an anode, the anode configured to absorb the electrons generated by the cathode, the anode at least partially coated by the electrolyte solution; and
an insulation plate, the insulation plate configured to absorb electrons, the insulation plate further configured for charge induction, the insulation plate defined by a material having a surface density of at least 0.0047 g/cm² in generally dry conditions, the insulation member at least partially coated by the electrolyte solution.

In another aspect, the cathode comprises a magnesium alloy.

In another aspect, the generally hydrophilic material of the cathode comprises a porosity of approximately between 5 percent and 95 percent.

In another aspect, the generally hydrophilic material of the cathode comprises a thickness approximately less than 2 millimeters.

In another aspect, the generally hydrophilic material of the cathode comprises at least one of the following: cotton, cellulose, Mitsumata, Kozo, and Ganpi.

In yet another aspect, the plurality of carbon nanotubes are defined by permeability and water retention characteristics.

In yet another aspect, the plurality of carbon nanotubes are defined by length approximately between 10⁻²Ω centimeters and 10⁴Ω centimeters.

In yet another aspect, the plurality of carbon nanotubes is defined by an external diameter approximately less than 150 nanometers.

In yet another aspect, the plurality of carbon nanotubes is defined by an external diameter approximately less than 30 nanometers.

In yet another aspect, the plurality of carbon nanotubes comprises a percentage of media thickness approximately between 0.2 and 3.

In yet another aspect, the plurality of carbon nanotubes comprises a percentage of media thickness approximately between 0.7 and 1.5.

In yet another aspect, the plurality of carbon nanotubes comprises a pH approximately between 6 and 7.5.

In yet another aspect, the plurality of carbon nanotubes comprise a diameter that is approximately 1/100 of a diameter of the generally hydrophilic material of the cathode.

In yet another aspect, the battery further comprises a solvent, the solvent comprising at least one of the following: water, tap water, and a solvent having a pH of about zero.

In yet another aspect, emersion of the anode and/or the insulation plate in the solvent at least partially actuates the battery.

In yet another aspect, the electrolyte solution comprises at least one of the following: calcium carbonate and/or citrate.

In yet another aspect, the calcium carbonate and/or the citrate is configured to coat the anode and the insulation plate.

In yet another aspect, the anode comprises a nonwoven panel, the nonwoven panel at least partially coated with a generally porous, high conductive carbon composition.

In yet another aspect, the anode comprises multiple anodes arranged in multiple layers to inhibit electrical leakage to neighboring cells.

In yet another aspect, the material of the insulation plate is paper.

In yet another aspect, the insulation plate comprises a paper filter material.

In yet another aspect, the battery further comprises a housing, the housing configured to contain the cathode, the anode, the insulation plate, and the electrolyte solution.

In yet another aspect, the anode is configured to form a rigid panel, the rigid panel fixedly disposed in the housing.

In yet another aspect, the battery further comprises an illumination device.

In yet another aspect, the illumination device comprises a device cathode and a device anode.

In yet another aspect, the device anode is configured to operatively connect to the cathode, and the device cathode is configured to operatively connect to the anode.

In yet another aspect, the illumination device comprises a light emitting diode.

In yet another aspect, the battery generates a voltage for illuminating the illumination device.

One objective of the present invention is to provide a battery that utilizes magnesium metal or metal alloys as the cathode for generating electrons.

Another objective is to provide a thin, lightweight battery fabricated from a plentiful, inexpensive metal, such as magnesium.

Another objective is to inhibit corrosion through the protective film formed by the magnesium cathode.

Another objective is to provide a chemically stable cathode with thin and hydrophilic surface for magnesium fuel sell with maximized contact area with the electrolyte solution.

Another objective is to provide a carbon nanotube composition having hydrophilic, absorptive characteristics that coats the cathode.

Yet another objective is to provide an insulation plate having the features of absorbency and charge induction with conductive porous material added, so that absorption of electrons by the anode is enhanced.

Yet another objective is to effectively combine cathode ionization and electron absorption by the cathode and, simultaneously combine the electrolyte solution, which determines the property of the electrolyte solution and solvent.

Yet another objective is to not require the use of insulation between cell layers to inhibit electrical leakage to neighboring cells through the use of multiple anodes arranged in multiple layers.

Yet another objective is to provide an insulation plate that operates as a charge inducer with water-absorbency.

Yet another objective is to provide an insulation plate that exhibits a capillary configuration.

Yet another objective is to provide an insulation plate that becomes conductive upon absorption of the electrolyte solution.

Yet another objective is to provide cost effective magnesium battery for powering an illumination device.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a diagram of an exemplary magnesium battery, in accordance with an embodiment of the present invention; and

FIG. 2 illustrates a flowchart of an exemplary method for actuating a magnesium battery, in accordance with an embodiment of the present invention.

Like reference numerals refer to like parts throughout the various views of the drawings.

### DETAILED DESCRIPTION OF THE INVENTION

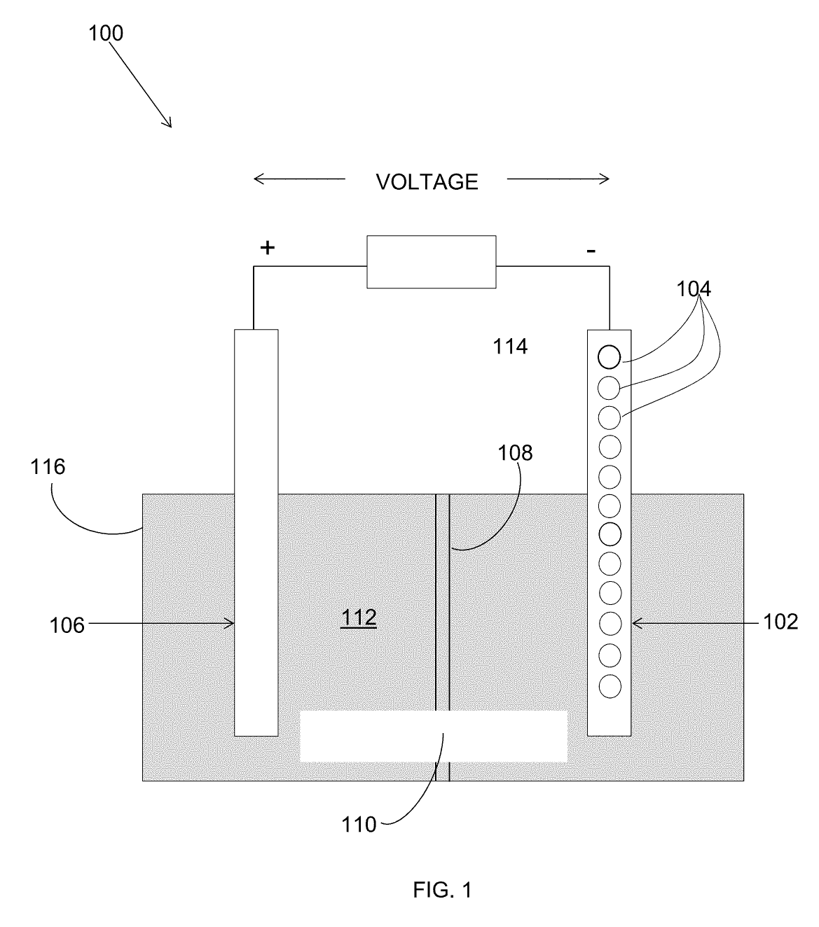

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “first,” “second,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” of this invention as required by 35 U.S.C. §112.

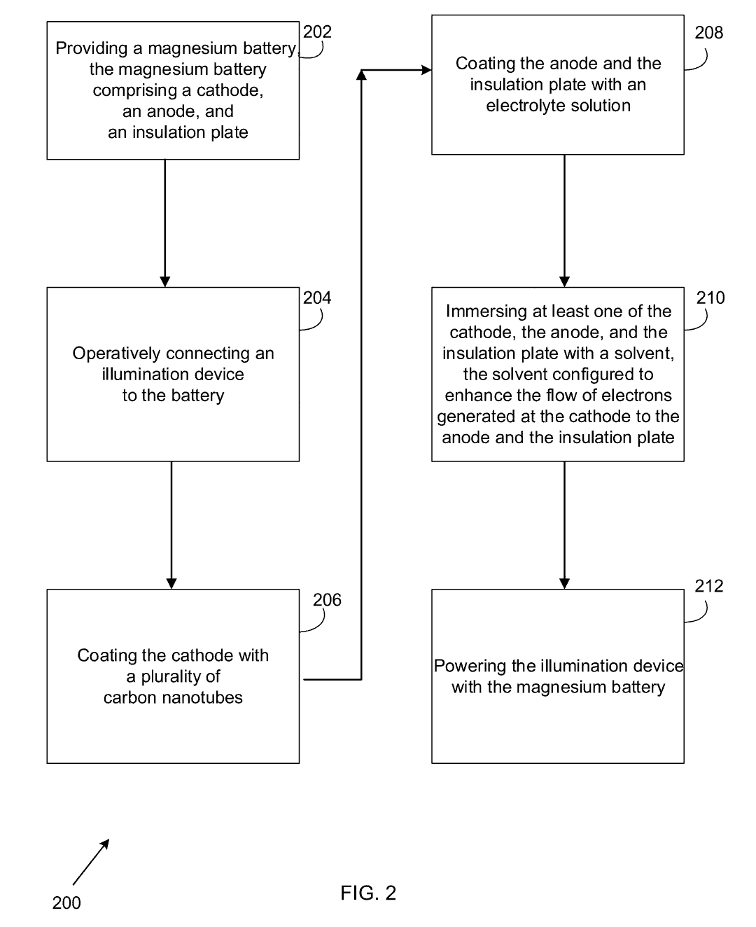

In one embodiment of the present invention presented in FIGS. 1-2, a magnesium battery 100 and method 200 for actuating the magnesium battery 100 provides a powerful, efficient battery that is also cost effective and lightweight due, chiefly to a magnesium metal composition. In some embodiments, the magnesium battery 100, hereafter, “battery 100” comprises of a cathode 102 that generates electrons and is fabricated at least partially from magnesium. The cathode 102 is coated with a plurality of carbon nanotubes 104 having hydrophilic characteristics, and configured to enhance conductivity of the cathode 102.

The battery 100 further comprises an anode 106 configured to absorb electrons that are generated by the cathode 102. This generated flow of electrons from cathode 102 to anode 106 enables formation of a circuit. The battery 100 further comprises an insulation plate 108 having conductive porous material with characteristics of absorbency and charge induction. The battery 100 may be thin and lightweight as a result of being fabricated from a plentiful and inexpensive metal, such as magnesium.

As referenced in FIG. 1, the battery 100 comprises a housing 116 that contains the components of the battery 100. The housing 116 may include a framework and a plurality of couplers for integrating the cathode 102, the anode 106, and the insulation plate 108 together. The housing 116 may also have an inlet for receiving a solvent 112 that actuates the battery 100.

In one embodiment, the housing 116 comprises a bottom surface having a generally elliptical shape. The housing 116 may include five compartments in a hollow portion. In one embodiment, a solvent 112, described below, can be injected into the space from the bottom surface of the housing 116. Because of such design, injection of the solvent 112 is simple and precise, resulting in the realization of the maximum performance, stability and preciseness of the battery 100.

In some embodiments, the battery 100 comprises a cathode 102. The cathode 102 is configured to generate electrons for oxidation associated with batteries. In one embodiment, the cathode 102 is fabricated at least partially from magnesium metal or a magnesium alloy. The unique magnesium metal or magnesium alloy composition of the cathode 102 enhances ionization so as to help inhibit corrosion from oxidation. This is possible because magnesium metal forms a protective film that inhibits oxidation. In one embodiment, the cathode 102 is thin and chemically stable, and also has a hydrophilic surface to enable maximized contact area with the electrolyte solution 110. In another embodiment, the cathode 102 is integrated into a recharging battery, performing electrolysis, whereby the cathode 102 forms a negative terminal, from which current exits the battery.

In one exemplary use of the battery 100, the unique magnesium metal or magnesium alloy composition of the cathode 102 enhances ionization so as to help inhibit corrosion from oxidation. This is possible because the magnesium metal forms a protective film that inhibits oxidation. Upon engagement with the solvent 112, the protective film forms through a non-dynamic dissolution. Further, the battery 100 has an appropriate reactive nature and can start activating power by a simple operation, even after a long preservation.

In some embodiments, the cathode 102 may include a paper fabrication having generally hydrophilic material. The hydrophilic material may have a porosity of approximately between 5% and 95%. The generally hydrophilic material of the cathode 102 may include a thickness approximately less than 2 millimeters. Though in one embodiment, the cathode 102 has a thickness approximately less than 1 millimeter. Suitable materials for the generally hydrophilic material of the cathode 102 may include, without limitation, cotton, cellulose, Mitsumata, Kozo, and Ganpi.

Those skilled in the art will recognize that magnesium metal is a chemical element with symbol Mg and atomic number 12. Magnesium, in the natural state, is a shiny gray solid. Further, because magnesium is the ninth most abundant mineral on earth, magnesium is plentiful and inexpensive. The magnesium metal that of the present invention enables creation of a battery 100 that is twice as efficient in power delivery, cheaper, and also easier to manufacture than the lithium-ion batteries known in the art, since Magnesium-ions are much more abundant that Lithium-ions.

In some embodiments, the cathode 102 is coated with a plurality of carbon nanotubes 104. The carbon nanotubes 104 are unique in that they have generally hydrophilic characteristics that enhance conductivity of the cathode 102. Thus, the carbon nanotubes 104 enhance electro conductivity of the cathode 102. This is possible through conductive fine particulate materialized carbon and minute squamous graphite that are mixed together. The graphite is chemically treated with the method of unexamined patent application 2003-59527 (P2003-59527A). Further, the conductive carbon is dampened with ethanol, methanol, or isopropyl alcohol to be added to the aqueous dispersion of the carbon nanotubes 104.

As a result of being coated with the carbon nanotubes 104, the cathode 102 is chemically stable, which helps inhibit corrosion. Further, binders are not necessary to retain the carbon nanotubes 104 on the cathode 102. By not using binders, conductivity of the cathode 102 is not disrupted and the cathode 102 has a thin, wide surface that is lightweight and efficient.

The carbon nanotubes 104 are especially effective when applied on the generally hydrophilic material of the cathode 102. For example, when thoroughly dried, a layer of carbon nanotubes 104 does not peel off from the cathode 102 or leak into the solvent 112. In one exemplary experiment of the cathode 102, dipping the cathode 102 that is coated with carbon nanotubes into water temperature of 50° Celsius for 5 hours and afterwards shaking the cathode 102 showed no sign of carbon nanotubes 104 peeling off the cathode 102.

In some embodiments, the plurality of carbon nanotubes 104 are defined by permeability and water retention characteristics. The carbon nanotubes 104 may also be defined by length approximately between 10⁻²Ω centimeters and 10⁴Ω centimeters. The carbon nanotubes 104 may also be defined by an external diameter approximately less than 150 nanometers. The carbon nanotubes 104 may also be defined by an external diameter approximately less than 30 nanometers. The carbon nanotubes 104 may be defined by a diameter that is approximately 1/100 of a diameter of the generally hydrophilic material of the cathode 102.

In yet other embodiments, the carbon nanotubes 104 may be defined by a percentage of media thickness (mt %) approximately between 0.2 and 3. Though in other embodiments, the mt % is between 0.7 and 1.5. The carbon nanotubes 104 may be defined a pH approximately between 6 and 7.5. Though in other embodiments, the pH is between 6.5 and 7.5. IN any case, the carbon nanotubes 104 are sized and dimensioned to increase the conductivity of the cathode 102.

In some embodiments, the battery 100 further comprises an anode 106 that is configured to absorb electrons that are generated by the cathode 102. This generated flow of electrons enables formation of a circuit. In one embodiment, the anode 106 is the positive terminal, which receives current from an external generator. Thus, the flow of electron current through a recharging battery is opposite to the direction of current during discharge. In essence, the electrode (anode 106 or cathode 102) which was the cathode 102 during battery discharge becomes the anode 106 while the battery is recharging.

In some embodiments, the anode 106 may be fabricated from a nonwoven panel that is at least partially coated with a generally porous, high conductive carbon composition. The anode 106 may also be configured to form a rigid panel that is fixedly disposed in the housing 116. In another embodiment, the anode 106 comprises multiple anodes arranged in multiple layers. By arranging the anodes in multiple layers electrical leakage to neighboring cells is inhibited, and an insulation is not required. This reduces the weight and cost of the battery 100.

In one embodiment, the anode 106 operatively connects to the cathode 102 through a plurality of connectors. Thus, the battery 100 effectively combines cathode 102 ionization and electron absorption by the cathode 102 and, simultaneously combine the electrolyte solution 110. This helps from the properties of an electrolyte solution 110 and a solvent 112, described below.

In some embodiments, the battery 100 further comprises an insulation plate 108 that, like the anode 106, is configured to absorb electrons generated by the cathode 102. The insulation plate 108 is defined by a generally conductive porous material with characteristics of absorbency and charge induction. Thus, the insulation plate 108 operates as a charge inducer with water-absorbency. In one embodiment, the insulation plate 108 includes the features of absorbency and charge induction with conductive porous material added, so that absorption of electrons by the anode 106 is enhanced. In another embodiment, the insulation plate 108 exhibits a capillary configuration.

In some embodiments, the insulation plate 108 is configured for charge induction. In another embodiment, the material of the insulation plate 108 has a surface density of at least 0.0047 g/cm² in generally dry conditions. In one embodiment, the material of the insulation plate 108 is a paper filter material. The insulation plate 108 may be disposed generally between the cathode 102 and the anode 106.

In some embodiments, an electrolyte solution 110 at least partially coats the anode 106 and/or the insulation plate 108. The electrolyte solution 110 may be a paste composition that is efficacious for coating. As a result of an overlaying layer of electrolyte solution 110 that is absorbed by the anode 106 and the insulation plate 108, the conductivity of the anode 106 and the insulation plate 108 increases. Thus, the anode 106 and the insulation plate 108 become more conductive of electrons upon absorption of the coat of electrolyte solution 110.

In one embodiment, the electrolyte solution 110 comprises at least one of the following: sea salt, glutamine sodium, calcium carbonate, and trisodium citrate. In another embodiment, the electrolyte solution 110 comprises calcium carbonate and/or citrate, which may also coat the anode 106 and/or the insulation plate 108.

As illustrated in FIG. 1, the battery 100 may further include a solvent 112 that is poured into the housing 116 so as to immerse at least one of the cathode 102, the anode 106, and the insulation plate 108. In one embodiment, immersion of the anode 106 and/or the insulation plate 108 in the solvent 112 at least partially actuates the battery 100 by reducing the barrier to the free flow of electrons. The solvent 112 may include water or tap water. Though in other embodiments, any solvent having a pH of about zero may be used.

In some embodiments, the battery 100 is configured to power an illumination device 114, such as a flash light, upon immersion in the solvent 112. In this configuration, the illumination device 114 serves as an external circuit load to the battery 100. The illumination device 114 comprises a device cathode 102 and a device anode 106. The device anode 106 is configured to operatively connect to the cathode 102, and the device cathode 102 is configured to operatively connect to the anode 106. In one embodiment, the illumination device 114 comprises a light emitting diode (LED).

Thus when the battery 100 is connected to the illumination device 114, the electrolyte solution 110 carries ions within, allowing the chemical reactions to be completed at the separate anode 106 and cathode 102 to deliver energy to the illumination device 114. It is the movement of the ions within the battery 100 which allows current to flow out of the battery 100 to power the illumination device 114. The battery 100, in essence, generates a voltage for illuminating the illumination device upon actuation by the solvent 112. Thus, the objective of providing a cost effective magnesium battery 100 for powering an illumination device 114 is satisfied.

As FIG. 2 illustrates, a method 200 for actuating the magnesium battery comprises an initial Step 202 of providing a magnesium battery 100, the magnesium battery 100 comprising a cathode 102, an anode 106, and an insulation plate 108, the cathode 102 fabricated substantially from magnesium, the anode 106 having a substantially hydrophilic, porous composition, the insulation plate 108 having properties of absorbency and charge induction. In this embodiment, the cathode 102 is configured to generate electrons for typical oxidation associated with batteries. In one embodiment, the cathode 102 is fabricated at least partially from magnesium metal or a magnesium alloy.

The anode 106 is configured to absorb electrons that are generated by the cathode 102. This generated flow of electrons enables formation of a circuit. In one embodiment, the anode 106 is the positive terminal, which receives current from an external generator. The anode 106 may be fabricated from a nonwoven panel that is at least partially coated with a generally porous, high conductive carbon composition. The insulation plate 108, like the anode 106, is configured to absorb electrons generated by the cathode 102. The insulation plate 108 is defined by a generally conductive porous material with characteristics of absorbency and charge induction.

A Step 204 includes operatively connecting an illumination device 114 to the battery 100. The illumination device may include a flashlight, and represents an external circuit load on the battery 100. In this configuration, the illumination device serves as an external circuit load to the battery 100. The illumination device comprises a device cathode 102 and a device anode 106. Each device electrode connects to a respective electrode on the battery 100.

A Step 206 may include coating the cathode 102 with a plurality of carbon nanotubes 104. The carbon nanotubes 104 are unique in that they have generally hydrophilic characteristics that enhance conductivity of the cathode 102. Thus, the carbon nanotubes 104 enhance electro conductivity of the cathode 102. This is possible through conductive fine particulate materialized carbon and minute squamous graphite that are mixed together.

In some embodiments, the method 200 may include a Step 208 of coating the anode 106 and the insulation plate 108 with an electrolyte solution 110. The electrolyte solution 110 is configured to initiate the generation and absorption of electrons. In one embodiment, the electrolyte solution 110 comprises at least one of the following: sea salt, glutamine sodium, calcium carbonate, and trisodium citrate.

A Step 210 comprises immersing at least one of the cathode 102, the anode 106, and the insulation plate 108 with a solvent 112, the solvent 112 configured to enhance the flow of electrons generated at the cathode 102 to the anode 106 and the insulation plate 108. The solvent 112 can be injected into the space from the bottom surface of the housing 116. Because of such design, injection of the solvent 112 is simple and precise, resulting in the realization of the maximum performance, stability and preciseness of the battery 100. The solvent 112 may include water or a solvent 112 having no pH value.

A final Step 212 comprises powering the illumination device 114. Thus when the battery 100 is connected to the illumination device 114, electrolyte solution 110 carries ions within, allowing the chemical reactions to be completed at the separate anode 106 and cathode 102 to deliver energy to the illumination device 114. It is the movement of the ions within the battery 100 which allows current to flow out of the battery 100 to power the illumination device 114.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What I claim is:

1. A magnesium battery, the battery comprising:
a cathode, the cathode comprising magnesium and a generally hydrophilic material, the cathode configured to generate electrons;
a plurality of carbon nanotubes, the plurality of carbon nanotubes configured to at least partially coat the cathode, the plurality of carbon nanotubes defined by a generally hydrophilic configuration;
an electrolyte solution, the electrolyte solution comprising of at least one of the following: sea salt, glutamine sodium, calcium carbonate, and trisodium citrate, the electrolyte solution configured to initiate the generation and absorption of electrons;
an anode, the anode configured to absorb the electrons generated by the cathode, the anode at least partially coated by the electrolyte solution; and
an insulation plate, the insulation plate configured to absorb electrons, the insulation plate further configured for charge induction, the insulation plate defined by a material having a surface density of at least 0.0047 g/cm² in generally dry conditions, the insulation member at least partially coated by the electrolyte solution.

2. The battery of claim 1, wherein the generally hydrophilic material of the cathode comprises a porosity of approximately between 5 percent and 95 percent.

3. The battery of claim 1, wherein the generally hydrophilic material of the cathode comprises a thickness approximately less than 2 millimeters.

4. The battery of claim 1, wherein the generally hydrophilic material of the cathode comprises at least one of the following: cotton, cellulose, Mitsumata, Kozo, and Ganpi.

5. The battery of claim 1, wherein the plurality of carbon nanotubes are defined by length approximately between 10⁻²Ω centimeters and 10⁴Ω centimeters.

6. The battery of claim 1, wherein the plurality of carbon nanotubes is defined by an external diameter approximately less than 150 nanometers.

7. The battery of claim 1, wherein the plurality of carbon nanotubes comprise an external diameter that is approximately 1/100 of a diameter of the generally hydrophilic material of the cathode.

8. The battery of claim 1, wherein the plurality of carbon nanotubes comprises a percentage of media thickness approximately between 0.2 and 3.

9. The battery of claim 1, wherein the plurality of carbon nanotubes comprises a pH approximately between 6 and 7.5.

10. The battery of claim 1, further including a solvent, the solvent configured to at least partially actuates the battery upon engagement with the anode and/or the insulation plate.

11. The battery of claim 10, wherein the solvent comprises at least one of the following: water, tap water, and a solvent having a pH of about zero.

12. The battery of claim 1, wherein the electrolyte solution comprises a calcium carbonate and/or a citrate.

13. The battery of claim 12, wherein the calcium carbonate and/or the citrate is configured to coat the anode and the insulation plate.

14. The battery of claim 1, wherein the anode comprises a nonwoven panel, the nonwoven panel at least partially coated with a generally porous, high conductive carbon composition.

15. The battery of claim 1, wherein the anode comprises multiple anodes arranged in multiple layers.

16. The battery of claim 1, wherein the insulation plate comprises a paper filter material.

17. The battery of claim 1, further including a housing, the housing configured to contain the cathode, the anode, the insulation plate, and the electrolyte solution.

18. The battery of claim 1, further including an illumination device.

19. The battery of claim 18, wherein the illumination device comprises a device cathode and a device anode, the device anode configured to operatively connect to the cathode, the device cathode configured to operatively connect to the anode.

20. A method for actuating a magnesium battery, the method comprising:
providing a magnesium battery, the magnesium battery comprising a cathode, an anode, and an insulation plate, the cathode fabricated substantially from magnesium, the anode having a substantially hydrophilic, porous composition, the insulation plate having properties of absorbency and charge induction;
operatively connecting an illumination device to the battery;
coating the cathode with a plurality of carbon nanotubes;
coating the anode and the insulation plate with an electrolyte solution;
immersing at least one of the cathode, the anode, and the insulation plate with a solvent, the solvent configured to enhance the flow of electrons generated at the cathode to the anode and the insulation plate; and
powering the illumination device with the magnesium battery.
